(19) United States
(12) Patent Application Publication
(10) Pub. No.: US 2025/0346476 A1
(43) Pub. Date: Nov. 13, 2025

(54) QUICK RELEASE CONNECTOR FOR BEVERAGE MACHINE AND CLEANING METHOD FOR THE BEVERAGE MACHINE

(71) Applicant: Food Industry Research and Development Institute, Hsinchu (TW)

(72) Inventors: Feng-Chi LIU, Tainan City (TW); Chun-Fong LIN, Hsinchu (TW); Yi-Jhen WU, Hsinchu (TW); Jia-Yan HOU, Tainan City (TW)

(21) Appl. No.: 18/949,150

(22) Filed: Nov. 15, 2024

(30) Foreign Application Priority Data
May 7, 2024 (TW) 113116861

(51) Int. Cl. B67D 1/08; A47J 31/44; A47J 31/60; B67D 1/07

(52) U.S. Cl. CPC B67D 1/0837; A47J 31/4403; A47J 31/60; B67D 1/07; B67D 2001/075

(57) ABSTRACT

A quick release connector is configured to be connected between a discharging end of a raw material supply member and a feeding end of a beverage machine, and includes a connector body and a raw material connecting tube. The connector body has a raw material end tube portion, and a machine end tube portion for connecting with the feeding end. The raw material end tube portion includes an outer tube section, a branch tube section for connection with a cleaning system, and a pushing section disposed inside the outer tube section. The raw material connecting tube is disposed in and slidable relative to the outer tube section between a cleaning position and a material supply position, and is configured to be connected to the discharging end of the raw material supply member. A cleaning method for the beverage machine is also disclosed.

### CROSS-REFERENCE TO RELATED APPLICATION

This application claims priority to Taiwanese Invention Patent Application No. 113116861, filed on May 7, 2024, and incorporated by reference herein in its entirety.

### FIELD

The present disclosure relates to a quick release connector, and more particularly to a quick release connector for a beverage machine and a method for cleaning the beverage machine.

### BACKGROUND

When a conventional beverage machine and a raw material supply member (e.g., a soft bag or a storage barrel containing raw material) are not yet connected, the connecting portions of the two are exposed to atmosphere and are susceptible to contamination. If there are residual raw materials at the connecting portion of the beverage machine from the previous usage, it is more likely to breed harmful bacteria. Furthermore, even if the connection between the beverage machine and the raw material supply member are cleaned before connection, the connection therebetween cannot be cleaned from the outside after the connection. In the above situation, the raw material passing through the connecting portions of the beverage machine and the raw material supply member is prone to contamination and spoilage, thereby causing food safety problems.

### SUMMARY

Therefore, an object of the present disclosure is to provide a quick release connector for a beverage machine and a cleaning method for the beverage machine that can alleviate at least one of the drawbacks of the prior art.

According to one aspect of this disclosure, the quick release connector is configured to be connected between a discharging end of a raw material supply member and a feeding end of a beverage machine, and includes a connector body and a raw material connecting tube. The connector body has a raw material end tube portion, and a machine end tube portion extending outwardly from one end of the raw material end tube portion for connecting with the feeding end of the beverage machine. The raw material end tube portion includes an outer tube section, a branch tube section extending transversely and downwardly from the outer tube section for connection with a cleaning system, and a pushing section disposed inside the outer tube section.

The raw material connecting tube is disposed in and slidable relative to the outer tube section between a cleaning position and a material supply position. The raw material connecting tube is configured to be connected to the discharging end of the raw material supply member. When the raw material connecting tube is in the cleaning position, it is relatively distal from the machine end tube portion, and a space in the branch tube section communicates with a space in the machine end tube portion through a space in the outer tube section. When the raw material connecting tube is in the material supply position, it is relatively close to the machine end tube portion, and the space in the branch tube section is blocked from communicating with the space in the outer tube section by a tube wall of the raw material connecting tube.

According to another aspect of this disclosure, the cleaning method for a beverage machine is implemented in cooperation with a cleaning system, the above quick release connector, and a raw material supply member. The cleaning system includes a detergent supply end. The raw material supply member has a discharging end with a discharging opening, and a resealable plug movable relative to the discharging opening between a closed position to close the discharging opening and an open position to open the discharging opening. The cleaning method comprises the steps of:
connecting the raw material connecting tube of the quick release connector to the discharging end of the raw material supply member, connecting the machine end tube portion of the connector body to a feeding end of the beverage machine, connecting the detergent supply end of the cleaning system to the branch tube section of the raw material end tube portion of the connector body, and sliding the raw material connecting tube to the cleaning position;
activating the cleaning system to supply detergent to the beverage machine through the detergent supply end thereof and the branch tube section and the machine end tube portion of the connector body; and
deactivating the cleaning system to stop supplying the detergent to the beverage machine and pushing the raw material supply member toward the quick release connector to slide the raw material connecting tube from the cleaning position to the material supply position and allow the pushing section of the raw material end tube portion to push the resealable plug to move from the closed position to the open position.

According to still another aspect of this disclosure, the cleaning method for the beverage machine is implemented in cooperation with a cleaning system, the above quick release connector, and a raw material supply member. The cleaning system includes a detergent supply end and a detergent recycling end. The quick release connector further comprises a three-way valve connected to the connector body. The raw material supply member has a discharging end with a discharging opening, and a resealable plug movable relative to the discharging opening between a closed position to close the discharging opening and an open position to open the discharging opening. The cleaning method comprises the steps of:
connecting the raw material connecting tube of the quick release connector to the discharging end of the raw material supply member, connecting a second tube portion of the three-way valve to a feeding end of the beverage machine, connecting the detergent supply end to a valve branch tube of the three-way valve, connecting the detergent recycling end to the branch tube section of the raw material end tube portion of the connector body, and sliding the raw material connecting tube to the cleaning position;
activating the cleaning system to supply detergent from the detergent supply end to the connector body through the valve branch tube and the first tube portion of the three-way valve, the detergent flowing back to the cleaning system through the branch tube section of the raw material end tube portion of the connector body and the detergent recycling end;
pushing the raw material supply member toward the quick release connector to slide the raw material connecting tube from the cleaning position to the material supply position and allow the pushing section of the raw material end tube portion of the connector body to push the resealable plug to move from the closed position to the open position;
activating the cleaning system to supply the detergent to the beverage machine through the detergent supply end thereof and the valve branch tube and the second tube portion of the three-way valve; and
deactivating the cleaning system to stop supplying the detergent to the beverage machine.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is a schematic view, illustrating how a quick release connector according to the first embodiment of the present disclosure can be connected to a raw material supply member, a beverage machine, and a cleaning system.

FIG. 2 is a flow chart of a cleaning method for the beverage machine applicable to the first embodiment.

FIGS. 3 to 5 are schematic views illustrating the execution steps of the cleaning method for the beverage machine applicable to the first embodiment, a flow direction of detergent being indicated by hollow arrows, and a flow direction of raw material being indicated by solid arrows.

FIG. 6 is a schematic view, illustrating how a quick release connector according to the second embodiment of the present disclosure can be connected to the raw material supply member, the beverage machine and the cleaning system.

FIG. 7 is a flow chart of a cleaning method for the beverage machine applicable to the second embodiment.

FIGS. 8 to 11 are schematic views illustrating the execution steps of the cleaning method for the beverage machine applicable to the second embodiment, the flowing direction of the detergent being indicated by hollow arrows, and the flowing direction of the raw material being indicated by solid arrows.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

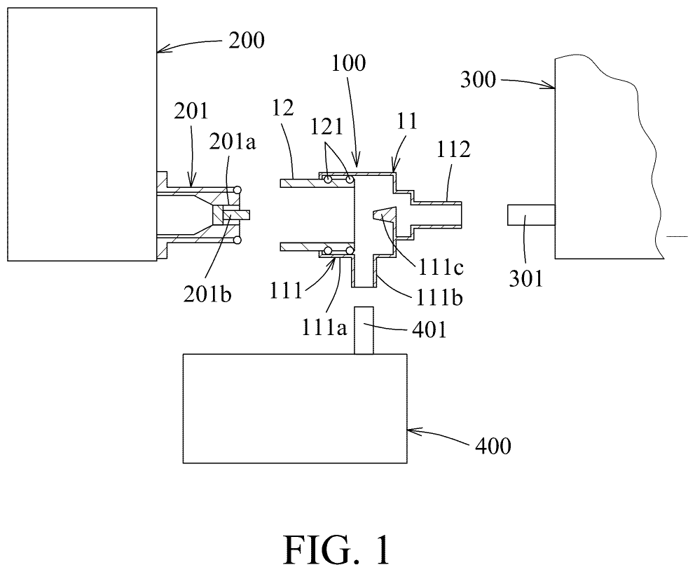

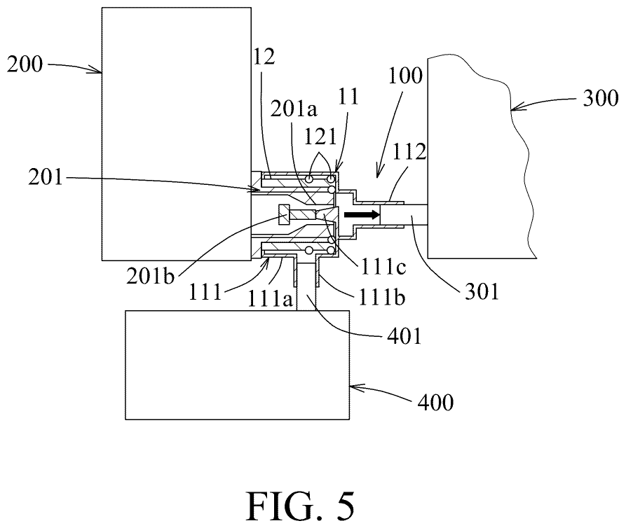

Referring to FIG. 1, a quick release connector 100 according to the first embodiment of the present disclosure is configured to be connected between a discharging end 201 of a raw material supply member 200 and a feeding end 301 of a beverage machine 300. The raw material supply member 200 may be, for example, but not limited to, a soft bag or a storage barrel containing raw material. The beverage machine 300 may be, for example, but not limited to, a smart blender or a tea bar machine. The discharging end 201 has a discharging opening (201a), and a resealable plug (201b) movable relative to the discharging opening (201a) between a closed position (see FIG. 1) to close the discharging opening (201a) and an open position (see FIG. 5) to open the discharging opening (201a). For example, the resealable plug (201b) may be acted upon by a force of an elastic member (not shown) provided at the discharging end 201 and driven to move toward the closed position so as to prevent the raw material in the raw material supply member 200 from leaking to the outside from the discharging end 201.

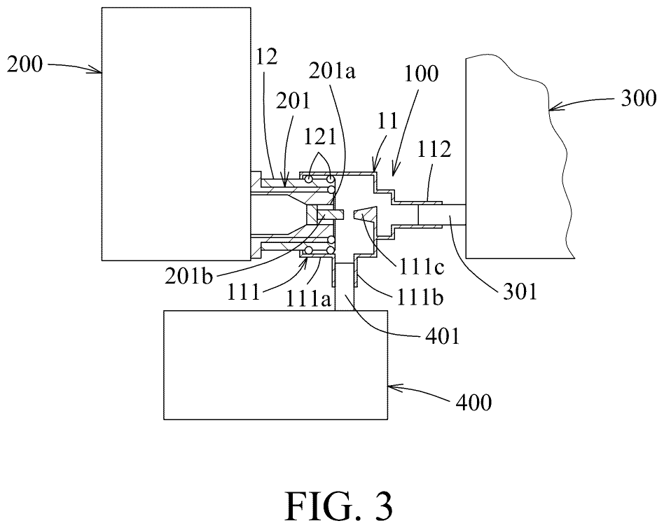

The quick release connector 100 includes a connector body 11 and a raw material connecting tube 12. The connector body 11 has a raw material end tube portion 111, and a machine end tube portion 112 extending outwardly from one end of the raw material end tube portion 111 for connecting with the feeding end 301 of the beverage machine 300. The raw material end tube portion 111 includes an outer tube section (111a), a branch tube section (111b) extending transversely and downwardly from the outer tube section (111a) for connecting with a cleaning system 400, and a pushing section (111c) disposed inside the outer tube section (111a) and adjacent to the machine end tube portion 112 for pushing the resealable plug (201b). The raw material connecting tube 12 is disposed in and slidable relative to the outer tube section (111a) between a cleaning position (see FIGS. 1 and 3) and a material supply position (see FIG. 5). The raw material connecting tube 12 is configured to be connected to the discharging end 201 of the raw material supply member 200. Specifically, in this embodiment, the quick release connector 100 further includes a plurality of gaskets 121 clamped between the outer tube section (111a) and the raw material connecting tube 12 to close a gap between an inner surface of the outer tube section (111a) and an outer surface of the raw material connecting tube 12.

Referring to FIG. 3, when the raw material connecting tube 12 is in the cleaning position, the raw material connecting tube 12 is relatively distal from the machine end tube portion 112, a space in the branch tube section (111b) communicates with a space in the machine end tube portion 112 through a space in the outer tube section (111a), and the resealable plug (201b) is located in the closed position. Referring to FIG. 5, when the raw material connecting tube 12 is in the material supply position, the raw material connecting tube 12 is relatively close to the machine end tube portion 112 and is surrounded by the outer tube section (111a), the space in the branch tube section (111b) is blocked from communicating with the space in the outer tube section (111a) by a tube wall of the raw material connecting tube 12, and the pushing section (111c) can push the resealable plug (201b) to move from the closed position to the open position. It should be noted that the sliding movement of the raw material connecting tube 12 from the cleaning position to the material supply position and vice versa can be accomplished by manual operation or by relying on other automated machinery.

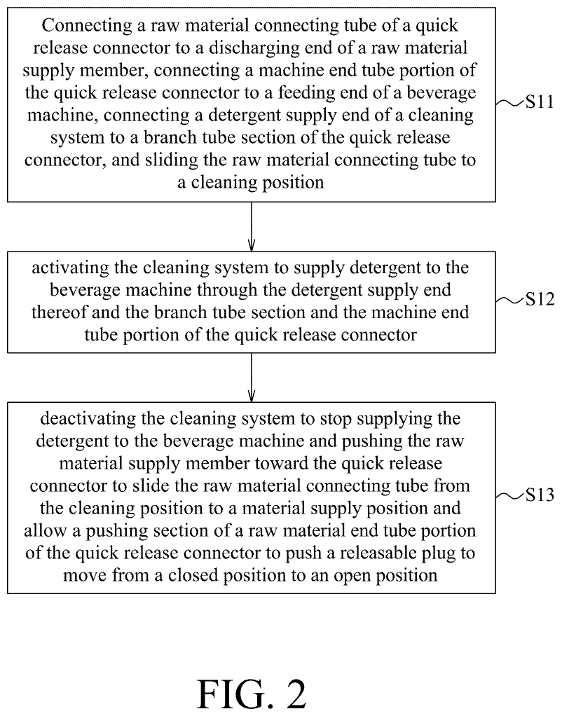

Referring to FIG. 2, in combination with FIGS. 1 and 3 to 5, a cleaning method for the beverage machine 300 is implemented in cooperation with the cleaning system 400, the quick release connector 100 of the first embodiment, and the raw material supply member 200. The cleaning system 400 is capable of supplying detergent, and includes a detergent supply end 401. The cleaning method includes steps S11 to S13.

In step S11, with reference to FIGS. 2 and 3, the raw material connecting tube 12 of the quick release connector 100 is connected to the discharging end 201 of the raw material supply member 200, the machine end tube portion 112 of the connector body 11 is connected to the feeding end 301 of the beverage machine 300, the detergent supply end 401 of the cleaning system 400 is connected to the branch tube section (111b) of the raw material end tube portion 111 of the connector body 11, and the raw material connecting tube 12 is slid to the cleaning position.

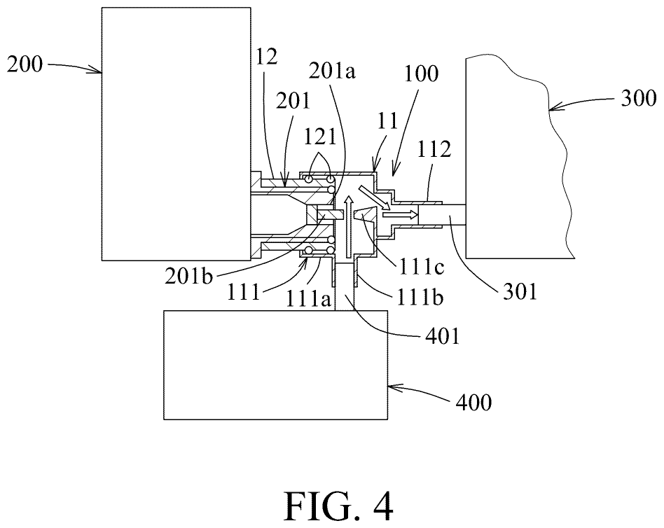

In step S12, with reference to FIGS. 2 and 4, the cleaning system 400 is activated to supply the detergent to the beverage machine 300 through the quick release connector 100. The detergent is a food-grade detergent. The detergent flows from the detergent supply end 401, and passes through the branch tube section (111b), the outer tube section (111a) and the machine end tube portion 112 of the connector body 11 into the beverage machine 300. In this step, the detergent can flow through the discharging end 201 of the raw material supply member 200, the interior of the connector body 11, and the feeding end 301 of the beverage machine 300 to clean the same. Moreover, the detergent can subsequently pass through internal piping of the beverage machine 300 to clean the same, and then flows out through an outlet (not shown) of the beverage machine 300.

In step S13, with reference to FIGS. 2 and 5, the cleaning system 400 is deactivated to stop supplying the detergent to the beverage machine 300, and the raw material supply member 200 is pushed toward the quick release connector 100 to slide the raw material connecting tube 12 from the cleaning position to the material supply position and allow the pushing section (111c) of the raw material end tube portion 111 to push the resealable plug (201b) to move from the closed position to the open position, thereby allowing the raw material supply member 200 to supply raw material to the beverage machine 300 through the quick release connector 100.

It should be noted that, after the beverage machine 300 is used for a certain period of time, the beverage machine 300 can undergo periodical cleaning (e.g., once every 4 hours) by repeating steps S11 to S13 to clean the discharging end 201 of the raw material supply member 200, the interior of the connector body 11, the feeding end 301 of the beverage machine 300, as well as the internal piping of the beverage machine 300 so as to maintain the cleanliness of the same. Furthermore, after each cleaning with the detergent (i.e., food-grade detergent), a step of rinsing the discharging end 201 of the raw material supply member 200, the interior of the connector body 11, the feeding end 301 of the beverage machine 300, and the internal piping of the beverage machine 300 with clean water may be performed to completely remove the detergent therefrom.

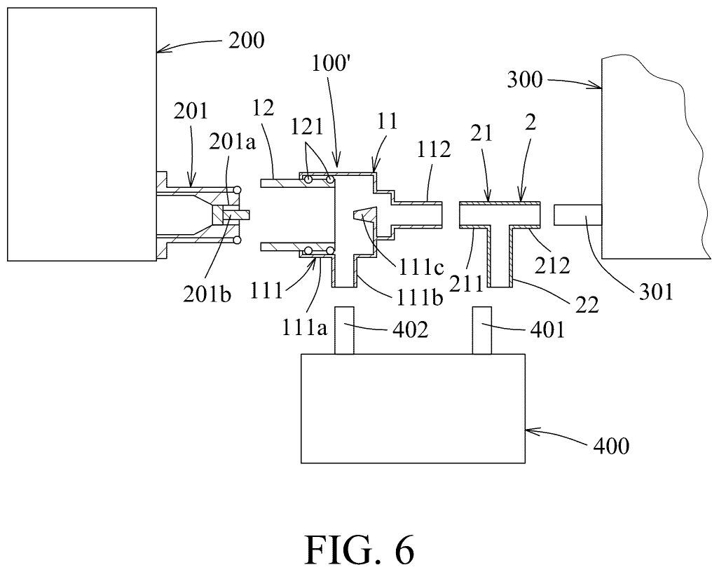

Referring to FIG. 6, the second embodiment of the quick release connector 100′ of this disclosure is substantially identical to the first embodiment, and differs from the first embodiment in that the quick release connector 100′ further includes a three-way valve 2 connected to the connector body 11. The three-way valve 2 includes a valve main tube 21, and a valve branch tube 22 extending transversely and downwardly from the main tube 21. The valve main tube 21 has a first tube portion 211 and a second tube portion 212 respectively located at two opposite sides of a top end of the valve branch tube 22. The first tube portion 211 is connected to the machine end tube portion 112 of the connector body 11. The second tube portion 212 is configured to be connected with the feeding end 301 of the beverage machine 300. The valve branch tube 22 is configured for connection with the cleaning system 400.

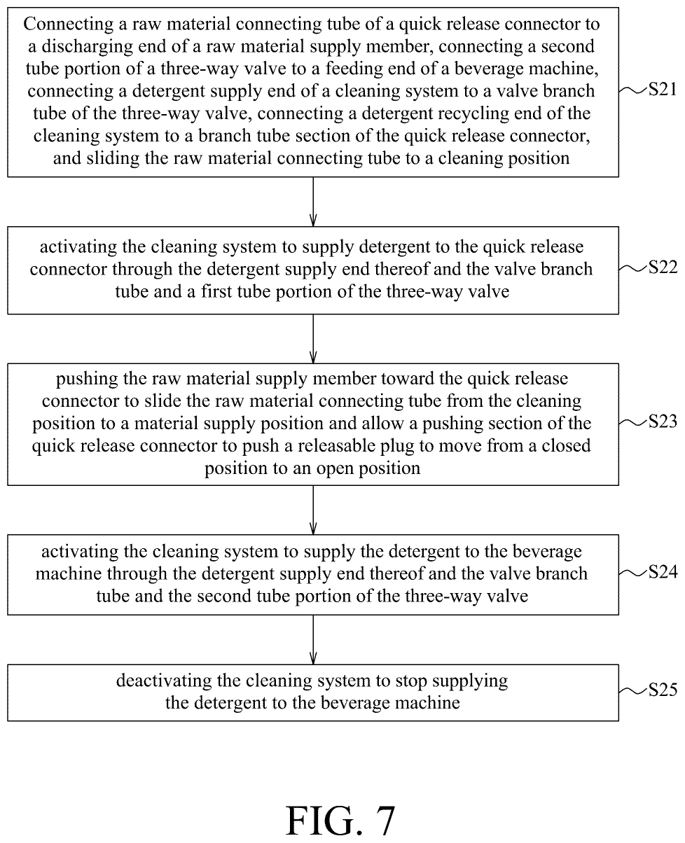

Referring to FIG. 7, in combination with FIGS. 6 and 8 to 11, a cleaning method for the beverage machine 300 is implemented in cooperation with the cleaning system 400, the quick release connector 100′ of the second embodiment, and the raw material supply member 200. The cleaning system 400 of the second embodiment further includes a detergent recycling end 402 for recycling the detergent. The cleaning method includes steps S21 to S25.

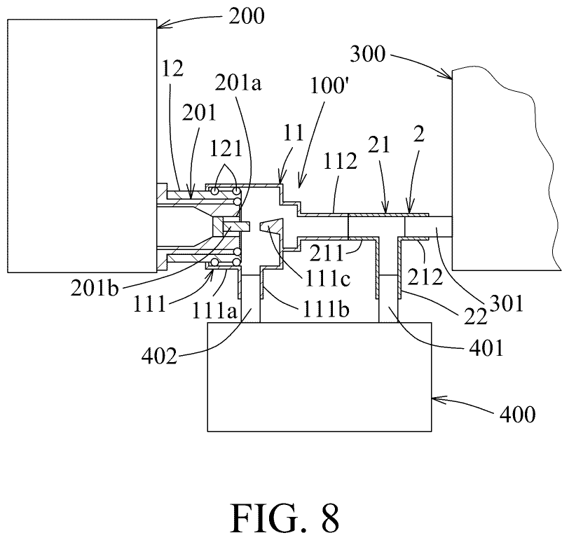

In step S21, with reference to FIGS. 7 and 8, the raw material connecting tube 12 of the quick release connector 100′ is connected to the discharging end 201 of the raw material supply member 200, the second tube portion 212 of the three-way valve 2 is connected to the feeding end 301 of the beverage machine 300, the detergent supply end 401 and the detergent recycling end 402 of the cleaning system 400 are respectively connected to the valve branch tube 22 of the three-way valve 2 and the branch tube section (111b) of the raw material end tube portion 111 of the connector body 11, and the raw material connecting tube 12 is slid to the cleaning position.

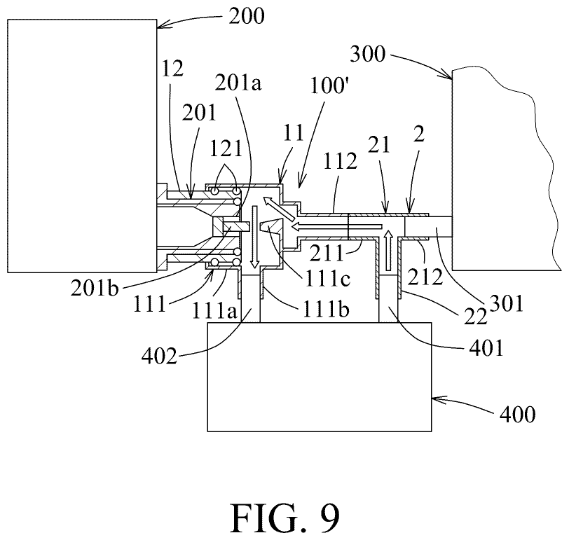

In step 22, with reference to FIGS. 7 and 9, the cleaning system 400 is activated to supply the detergent to the connector body 11. The detergent flows from the detergent supply end 401, and passes through the valve branch tube 22 and the first tube portion 211 of the three-way valve 2 into the connector body 11. The detergent flows back to the cleaning system 400 through the branch tube section (111b) of the raw material end tube portion 111 of the connector body 11 and the detergent recycling end 402 of the cleaning system 400. In this step, the detergent can flow through the valve branch tube 22 and the first tube portion 211 of the three-way valve 2, the interior of the connector body 11, and the discharging end 201 of the raw material supply member 200 to clean the same.

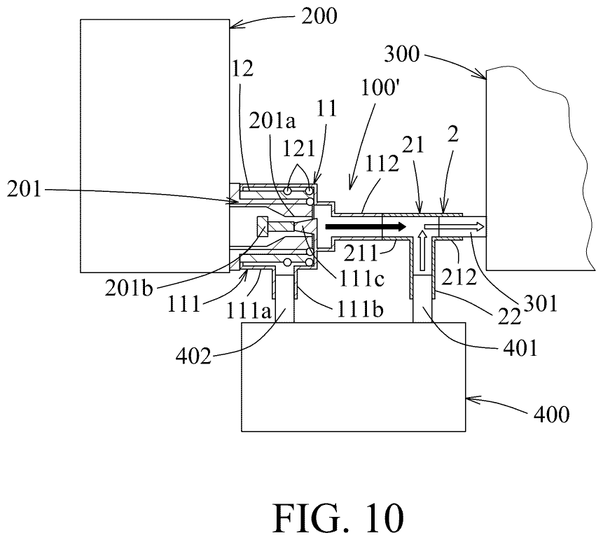

In step 23, with reference to FIGS. 7 and 10, the raw material supply member 200 is pushed toward the quick release connector 100′ to slide the raw material connecting tube 12 from the cleaning position to the material supply position and allow the pushing section (111c) of the raw material end tube portion 111 of the connector body 11 to push the resealable plug (201b) to move from the closed position to the open position.

In step S24, the cleaning system 400 is activated to supply the detergent to the beverage machine 300. The detergent flows from the detergent supply end 401, and passes through the valve branch tube 22 and the second tube portion 212 of the three-way valve 2 into the beverage machine 300. In this step, the raw material supply member 200 can supply raw material to the first tube portion 211 of the three-way valve 2 through the connector body 11, and the detergent can flow from the detergent supply end 401 and pass through the interiors of the valve branch tube 22 and the second tube portion 212 of the three-way valve 2 and the feeding end 301 of the beverage machine 300 so as to clean the same. Furthermore, the detergent can also pass through the internal piping of the beverage machine 300 to clean the same, and can then flow out through the outlet (not shown) of the beverage machine 300.

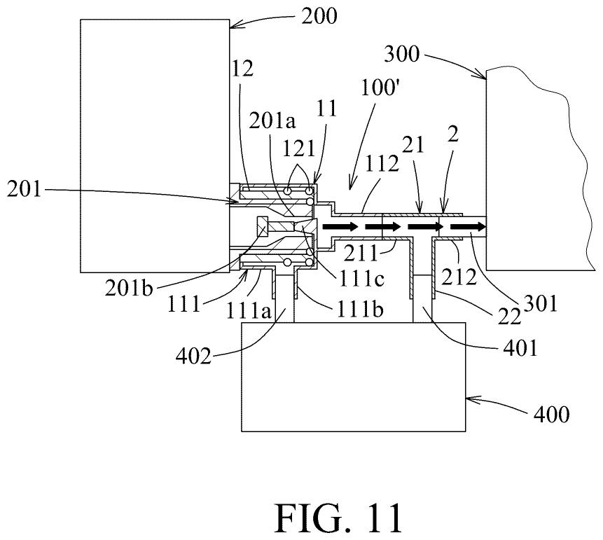

In step 25, with reference to FIGS. 7 and 11, the cleaning system 400 is deactivated to stop supplying the detergent to the beverage machine 300 through the detergent supply end 401 thereof, and the raw material supply member 200 can continuously supply the raw material to the beverage machine 300 through the connector body 11 and the three-way valve 2.

It should be noted that, after the beverage machine 300 is used for a certain period of time, the beverage machine 300 can undergo periodical cleaning (e.g., once every 4 hours) by repeating steps S24 and S25 to clean the interiors of the valve branch tube 22 and the second tube portion 212 of the three-way valve 2, the feeding end 301 of the beverage machine 300 and the internal piping of the beverage machine 300 so as to maintain the cleanliness of the same.

Furthermore, after the beverage machine 300 is used for a certain period of time, the beverage machine 300 can also undergo periodical cleaning (e.g., once a day) by repeating the step of “sliding the raw material connecting tube 12 to the cleaning position” in step S21, and sequentially performing steps S22, S23 and S25 to clean the interiors of the valve branch tube 22 and the second tube portion 212 of the three-way valve 2 and the feeding end 301 of the beverage machine 300, so as to maintain the cleanliness of the same. Moreover, after each cleaning operation with the detergent (i.e., food-grade detergent), a step of rinsing the interiors of the valve branch tube 22 and the second tube portion 212 of the three-way valve 2 and the feeding end 301 of the beverage machine 300 with clean water may be performed to completely remove the detergent therefrom.

In summary, by using the branch tube section (111b) of the raw material end tube portion 111 of the connector body 11 of the quick release connector 100, 100′ for connection with the cleaning system 400, when the raw material connecting tube 12 is in the cleaning position, the cleaning system 400 can provide the detergent to the quick release connector 100, 100′ for cleaning the discharging end 201 of the raw material supply member 200 and the feeding end 301 of the beverage machine 300. Furthermore, when the raw material connecting tube 12 is in the material supply position, the space in the branch tube section (111b) is blocked from communicating with the space in the outer tube section (111a) by the tube wall of the raw material connecting tube 12 to prevent passage of the detergent therethrough, thereby allowing the raw material in the raw material supply member 200 to enter the quick release connector 100, 100′ or the beverage machine 300 through the quick release connector 100, 100′. Through this, the connection between the beverage machine 300 and the raw material supply member 200 can be conveniently and easily cleaned by the cleaning system 400 to prevent growth of harmful bacteria and prevent the raw material from contamination and spoilage when passing through the connection between the beverage machine 300 and the raw material supply member 200. Hence, the occurrence of food safety problems can be prevented.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A quick release connector configured to be connected between a discharging end of a raw material supply member and a feeding end of a beverage machine, comprising:
a connector body having a raw material end tube portion, and a machine end tube portion extending outwardly from one end of said raw material end tube portion for connecting with the feeding end of the beverage machine, said raw material end tube portion including an outer tube section, a branch tube section extending transversely and downwardly from said outer tube section for connection with a cleaning system, and a pushing section disposed inside said outer tube section; and a raw material connecting tube disposed in said outer tube section and slidable relative to said outer tube section between a cleaning position and a material supply position, said raw material connecting tube being configured to be connected to the discharging end of the raw material supply member;
wherein, when said raw material connecting tube is in the cleaning position, said raw material connecting tube is relatively distal from said machine end tube portion, and a space in said branch tube section communicates with a space in said machine end tube portion through a space in the outer tube section;
and, when said raw material connecting tube is in the material supply position, said raw material connecting tube is relatively close to said machine end tube portion, and said space in said branch tube section is blocked from communicating with said space in said outer tube section by a tube wall of said raw material connecting tube.

2. The quick release connector as claimed in claim 1, further comprising a three-way valve connected to said connector body, said three-way valve including a valve main tube, and a valve branch tube extending transversely and downwardly from said valve main tube, said valve main tube having a first tube portion and a second tube portion respectively located at two opposite sides of a top end of said valve branch tube, said first tube portion being connected to said machine end tube portion of said connector body, said second tube portion being configured to be connected with the feeding end of the beverage machine, said valve branch tube being configured for connection with the cleaning system.

3. A cleaning method for a beverage machine implemented in cooperation with a cleaning system, the quick release connector as claimed in claim 1, and a raw material supply member, the cleaning system including a detergent supply end, the raw material supply member having a discharging end with a discharging opening, and a resealable plug movable relative to the discharging opening between a closed position to close the discharging opening and an open position to open the discharging opening, the cleaning method comprising the steps of:
connecting the raw material connecting tube of the quick release connector to the discharging end of said raw material supply member, connecting the machine end tube portion of the connector body to a feeding end of the beverage machine, connecting the detergent supply end of the cleaning system to the branch tube section of the raw material end tube portion of the connector body, and sliding the raw material connecting tube to the cleaning position;
activating the cleaning system to supply detergent to the beverage machine through the detergent supply end thereof and the branch tube section and the machine end tube portion of the connector body; and
deactivating the cleaning system to stop supplying the detergent to the beverage machine and pushing the raw material supply member toward the quick release connector to slide the raw material connecting tube from the cleaning position to the material supply position and allow the pushing section of the raw material end tube portion to push the resealable plug to move from the closed position to the open position.

4. A cleaning method for a beverage machine implemented in cooperation with a cleaning system, the quick release connector as claimed in claim 2, and a raw material supply member, the cleaning system including a detergent supply end and a detergent recycling end, the raw material supply member having a discharging end with a discharging opening, and a resealable plug movable relative to the discharging opening between a closed position to close the discharging opening and an open position to open the discharging opening, the cleaning method comprising the steps of:
connecting the raw material connecting tube of the quick release connector to the discharging end of the raw material supply member, connecting the second tube portion of the three-way valve to a feeding end of the beverage machine, connecting the detergent supply end to the valve branch tube of the three-way valve, connecting the detergent recycling end to the branch tube section of the raw material end tube portion of the connector body, and sliding the raw material connecting tube to the cleaning position;
activating the cleaning system to supply detergent from the detergent supply end to the connector body through the valve branch tube and the first tube portion of the three-way valve, the detergent flowing back to the cleaning system through the branch tube section of the raw material end tube portion of the connector body and the detergent recycling end;
pushing the raw material supply member toward the quick release connector to slide the raw material connecting tube from the cleaning position to the material supply position and allow the pushing section of the raw material end tube portion of the connector body to push the resealable plug to move from the closed position to the open position;
activating the cleaning system to supply the detergent to the beverage machine through the detergent supply end thereof and the valve branch tube and the second tube portion of the three-way valve; and
deactivating the cleaning system to stop supplying the detergent to the beverage machine.
